(19) United States
(12) Patent Application Publication
(10) Pub. No.: US 2015/0039376 A1
(43) Pub. Date: Feb. 5, 2015

(54) Real Time Allocation Engine For Merchandise Distribution

(71) Applicant: Timo Vogelgesang, Blieskastel-Biesingen (DE)

(72) Inventor: Timo Vogelgesang, Blieskastel-Biesingen (DE)

(73) Assignee: SAP AG, Walldorf (DE)

(21) Appl. No.: 13/955,736

(22) Filed: Jul. 31, 2013

(51) Int. Cl. G06Q 10/06; G06Q 10/08

(52) U.S. Cl. CPC G06Q 10/06315; G06Q 10/087
USPC 705/7.25

(57) ABSTRACT

A system includes an allocation table configured for use in a push-driven retail allocation business. The configuration for the push-driven retail allocation business includes a centrally organized headquarter office and a plurality of distribution points. The merchandise is procured by the centrally organized headquarter office and distributed under guidance of the centrally organized headquarter office to the plurality of distribution points. The system also includes an allocation engine processor logically coupled to the allocation table, and an in-memory database logically coupled to the allocation engine processor. The system procures the merchandise from a vendor and distributes the merchandise to the plurality of distribution points by identifying an article of merchandise, determining a current stock status of the article of merchandise, determining one or more distribution points for the article of merchandise, and determining an allocation strategy to the one or more distribution points for the article of merchandise.

### TECHNICAL FIELD

The present disclosure relates to a system for the distribution of merchandise, and in an embodiment, but not by way of limitation, a real time allocation engine for the distribution of merchandise.

### BACKGROUND

In retail businesses, the distribution of some groups of articles to stores (especially seasonal, trendy, promotional, and fashion products) follows a push-driven approach that is centrally organized and controlled by a department in a centrally organized headquarter office. Such push-driven processes are referred to as allocation processes in retail businesses.

Often, such allocation processes are executed at regular time intervals (e.g., daily or every few hours), and therefore are automated by scheduled jobs of the underlying software. At the same time, such push-driven allocation processes often represent very time-consuming jobs that have to handle huge data volumes. Consequently, run and response times are always very critical in allocation processes. However, the available time window for such allocation processes is becoming increasingly shortened since many operations have to be handled before allocation (such as prerequisites, especially pre-calculation of key performance indicators (KPIs) that are used in allocation calculations), and other operations have to be handled after allocation (such as follow-on processing, especially logistics execution). At the same time, such processing-intensive jobs cannot be executed during the day, since users would be adversely affected in their online work. As a consequence, allocation in today's business environment, especially the retail business environment, is mostly taken care of by nightly job networks with a high criticality related to runtime and usage of pre-calculated data like KPIs from business intelligence solutions.

### BRIEF DESCRIPTION OF THE DRAWINGS

FIG. 1 illustrates an example of an allocation table that can be used in connection with an implementation of push-driven allocation processes.

FIG. 2 illustrates an example of automated store allocation on an allocation table framework.

FIG. 3 illustrates a structure of a real-time allocation approach of an in-memory database in an allocation system that uses a traditional database.

FIG. 4 illustrates another structure of a real-time allocation approach using only an in-memory database.

FIGS. 5A and 5B are a block diagram illustrating operations and features of an allocation system embedded in an in-memory database.

FIG. 6 is a block diagram of a computer system upon which one or more embodiments of the present disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Several functions would benefit retail businesses in an allocation processing system, and in particular, a push-driven allocation system. For example, a high degree of automation in a push-driven allocation system would be beneficial. Specifically, retail businesses in general tolerate manual intervention only in exceptional and limited circumstances. Also, retail businesses focus on results instead of the retrieval of data. Additionally, retail businesses prefer to work with real-time data (e.g., current stocks of merchandise, allocation key performance indicators (KPIs), and allocation parameters). Simply put, retail businesses would like real-time allocation results rather than nightly allocation batch jobs embedded into complex job networks. Such retail businesses would further desire and benefit from online execution of simulations, “what-if” analyses, and final activations of allocations based on settings of a best valuated scenario or alternative.

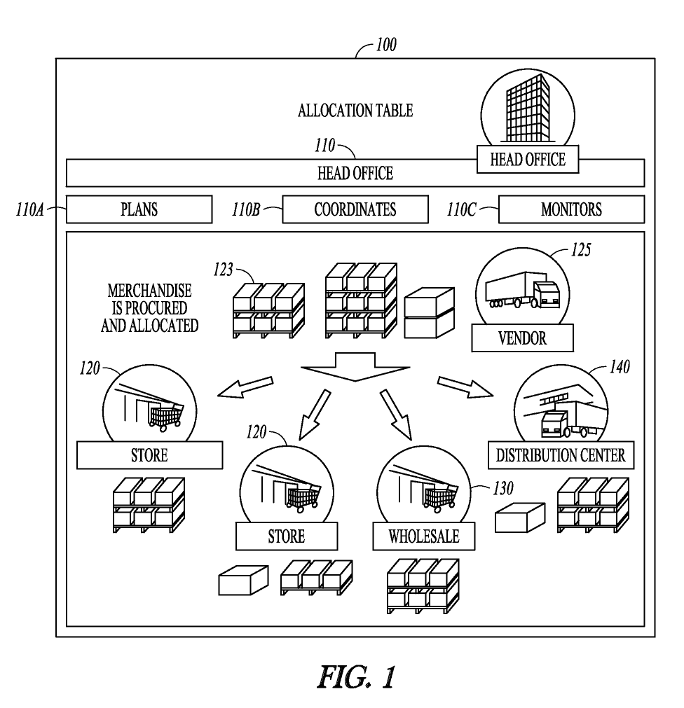

FIG. 1 illustrates an allocation table 100. The allocation table 100 can be a data object and a software module for the implementation of push-driven allocation processes. The allocation table 100 supports a more manual working mode for centrally-organized and push-driven allocation processes, because as noted above, an online implementation of such an allocation would adversely and unacceptably impact user response time. The allocation table 100 includes data relating to plans 110A, coordinates 110B, and monitors 110C. The allocation table 100 further reflects that merchandise 123 is secured from a vendor 125, and distributed to stores 120, wholesalers 130, and distribution centers 140. In an embodiment, the plans 110A relate to anticipated steps and operations to distribute the merchandise 123 to the stores 120, wholesalers 130, and distribution centers 140. For example, the plans 110A may include the identity and quantity of merchandise 123 that will be distributed to a certain store 120 at a certain time period via a certain means of transportation. The coordinates 110B relate to the different points in the distribution process through which the merchandise will travel before it arrives at its final destination (stores 120, wholesalers 130, and distribution centers 140). The monitors 110C relate to processes, steps, and operations that track the merchandise as it travels through the distribution process.

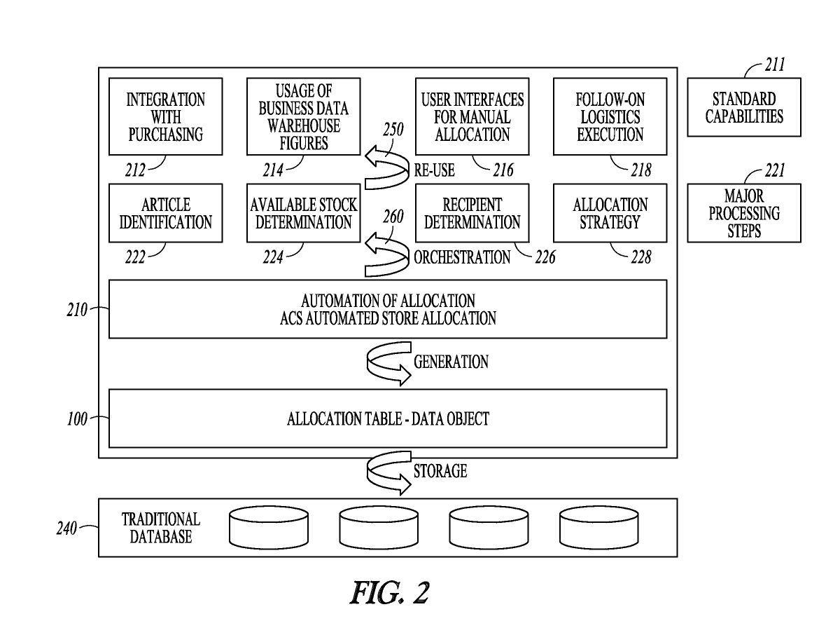

FIG. 2 illustrates an example of an automated store allocation on an allocation table framework 100, and in particular, an adaptable custom solution (ACS) for an automated store allocation 210 in a retail environment. The ACS addresses a lack of automation in a standard allocation table framework, and thereby targets businesses with seasonal goods and typical multi-step mass volume allocation processes. For example, the high fashion business uses a multi-step store allocation approach that includes initial allocation, daily subsequent allocation/replenishment, and final allocation. In the example of an ACS of FIG. 2, standard capabilities 211 include such functions as integration with purchasing 212, usage of data from a business data warehouse 214, user interfaces for manual allocation 216, and execution of follow-on logistics 218. The integration with purchasing 212 includes, for example, a determination of how much of an article of merchandise the central headquarter office should purchase. In combination with the purchasing 212, the business data warehouse 214 is queried to determine how much of the article of merchandise is already on hand. At 216, a user interface can allow a user at the central headquarter office to purchase more or less of an article of merchandise, and/or to distribute more or less of that article of merchandise to a particular final destination.

FIG. 2 further illustrates how the automated store allocation 210 is positioned on top of the allocation table 100, which in turn is positioned on a traditional database 240, and basically re-uses at 250 the following major concepts/standard capabilities of the allocation table in order to enable an automated allocation process flow—article identification, available stock determination, recipient determination, and allocation strategy. These standard capabilities 211 can be used similar to user exits or business add-ins so that retailers can implement their own specialized and optimized business logic for the identification of articles, their available quantities, the potential receivers of these quantities, and finally which specific quantity to which receiver at what point in time.

The ACS also includes the processing steps 221 of article identification 222, determination of available stock 224 of the article of merchandise, determination of the recipient of the article of merchandise at 226, and an allocation strategy 228. An allocation strategy 228 normally involves consideration of the quantity of merchandise, the distribution logistics for the merchandise, and the final distribution points for the merchandise.

The ACS orchestrates at 260 these major processing steps of allocation and finally generates allocation tables 100 as data objects on the traditional database 240 on which the system is running By using the allocation table as a data object that is embedded into the allocation table framework 100, the ACS automated store allocation 210 offers retailers access to the standard capabilities that enable an end-to-end allocation process implementation. As explained above, the ACS automated store allocation 210 provides integration with purchasing 212 as a preceding step in the merchandising lifecycle. It offers at 214 retrieval of KPIs (such as current sales data and current stock data) from the business data warehouse for usage in the allocation calculation logic. It includes user interfaces 216 for review and manual interaction on allocation calculation results. It further provides follow-on document generation for the logistics execution of allocation 218.

In summary, the ACS automated store allocation 210 enables the implementation and automation of push-driven allocation processes. However, current allocation systems are lacking in several functions. For example, real-time allocation with all its advantages, especially usage of fresh data (e.g., merchandise in stock, KPIs, and other parameters) and online interaction and simulation with the user, is currently still out of reach for the retail community.

Consequently, in an embodiment, a real-time allocation engine is created by embedding the allocation engine into an in-memory database, such as the HANA® in-memory database offered by SAP®. This real-time allocation engine is then employed in a push-driven allocation process. There are several reasons why push-driven allocation processes work well in connection with in-memory computing. Push-driven processes represent massive volumes of business. In-memory computing speeds the processing of these massive volumes of business. Push-driven processes are daily, time-critical jobs with limited processing time windows. Once again, the speed of in-memory computing assists in meeting these time critical jobs and limited processing windows. In current push-driven processing systems, jobs are scheduled during the night in order to not interfere with the work of users on the system. With in-memory processing, processing can be performed in real-time during the day.

Additionally, allocation processing steps are intensive, both from the data retrieval point of view and the data processing perspective. In particular, the following core allocation steps are process intensive—article identification (222), determination of potential receivers (226), allocation calculation logic (228), and the retrieval of KPIs from a business data warehouse (214). Also, allocation processes use aggregated key figures that have to be intensively pre-calculated in data warehouse systems. A lot of time can be spent on retrieving the required parameters, master data, and KPIs from various database sources in order to analyze them in the underlying allocation calculation logic. It should be noted that current allocation solutions are characterized by technical limitations of the past. However, with in-memory computing technology, retail businesses will be able to implement new potentials that drive new solution approaches. Since retailers often define their uniqueness and business success related to the way in which they distribute merchandise, allocation will get even more attention in light of embodiments of this disclosure, and the allocation engine can play a major role in this new allocation solution space.

The innovation of a real-time allocation engine embedded into an in-memory database offers the following achievements and benefits for the retail industry. There is a tremendous speed-up of run times of push-driven allocation processes. Allocation moves from a batch-driven night-time business towards an online daily interactive work in collaboration with the user. The allocation engine offers the foundation for real-time allocation on-demand with simulation and “what-if” analysis capabilities. There is no need for exhaustive pre-calculation and aggregation of KPIs in a business data warehouse for their usage in allocation if the data foundation is given in an in-memory database. Allocation KPIs can be calculated on-the-fly in the in-memory database, thereby providing real-time KPIs, stock data, and sales figures. The user can receive direct feedback on any changes in the settings (that is, a “what-if” analysis), thereby achieving better results by focusing on optimizing and not controlling the allocation processes. Allocation engine exposure to new use cases for retail businesses has just not been possible in the past due to software/hardware limitations of a system without an in-memory database. The allocation engine can be implemented in a current as-is non in-memory system environment of retailers. There also can be full integration with purchasing and logistics by re-using currently existing allocation table frameworks and its stable, integrated document flow from ordering through logistics execution (250, 260). In an embodiment of the allocation engine embedded in an in-memory database, there is no extensive implementation work required since major parts of already existing allocation table implementation can be re-used. Consequently, a user can focus on acceleration and elaboration of new use cases as they are made possible by the new in-memory database technology. Many retailers are currently using allocation concepts and are therefore already familiar with the allocation table concepts, so no additional training and consulting work is required.

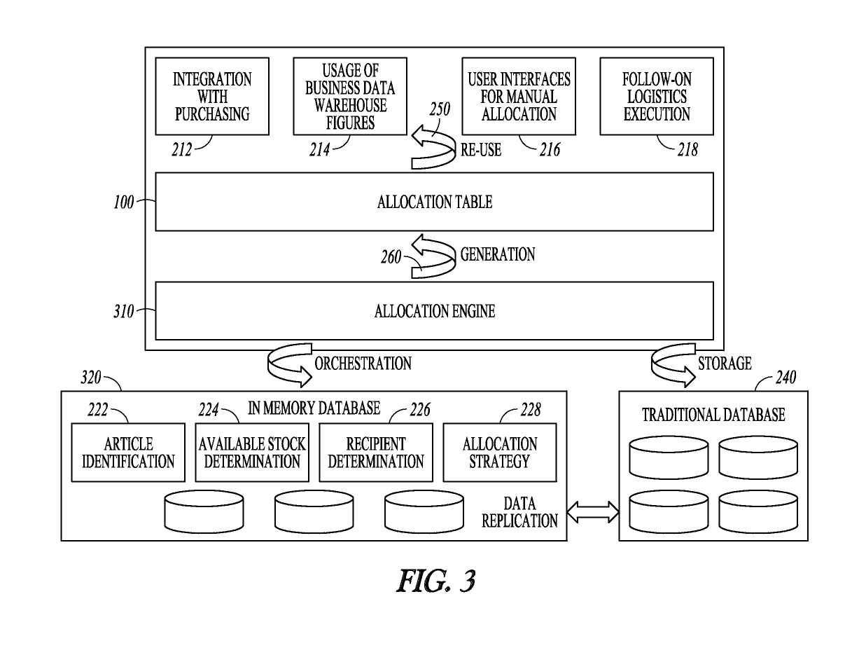

FIG. 3 illustrates a structure of a real-time allocation approach of an in-memory database 320 in a current allocation system that uses a traditional database 240. Specifically, FIG. 3 shows a side-by-side database approach of an in-memory database and a traditional database. All the data (master data, allocation parameters, stock figures, sales data, tickets, etc.) that are required by the allocation processes and the underlying calculations are replicated from the traditional database 240 to the in-memory database 320. As illustrated in FIG. 3, the allocation table has access to the following features—integration with purchasing 212, a business data warehouse 214, user interfaces for manual allocation 216, and follow on logistics execution 218, as is the case in current traditional allocation systems. The data needed for the allocation process is replicated from the traditional database 240 to the in-memory database 320. The allocation engine can then process the data in the in-memory database to execute the primary functions of the allocation process—article identification 222, available stock determination 224, recipient determination 226, and allocation strategy 228.

The allocation engine 310 includes the following features and benefits in the side-by-side architecture with a traditional database as illustrated in FIG. 3. The primary allocation services of article identification 222, available stock determination 224, recipient determination 226, and allocation strategy 228 are relocated and provided on the in-memory database 320. The embedding of the allocation engine 310 into a standard allocation table framework 100 permits the re-use of already existing standard capabilities 211 like integration with ordering 212 and logistics execution 218, as well as the provision of user interfaces 216 for the manual review and interaction on allocation results as calculated on the in-memory database with the new architecture. The allocation services on the in-memory database 320 are open, flexible, and freely-definable anchor points for custom-specific allocation calculation logic. The allocation engine 310 in connection with the in-memory database 320 supports on-the-fly calculation, accumulation, and aggregation scenarios for allocation KPIs, instead of pre-calculation in a business data warehouse and remote retrieval by allocation processes. Additionally, on-the-fly calculation allows usage of real-time KPIs and thereby enables real-time allocation processing.

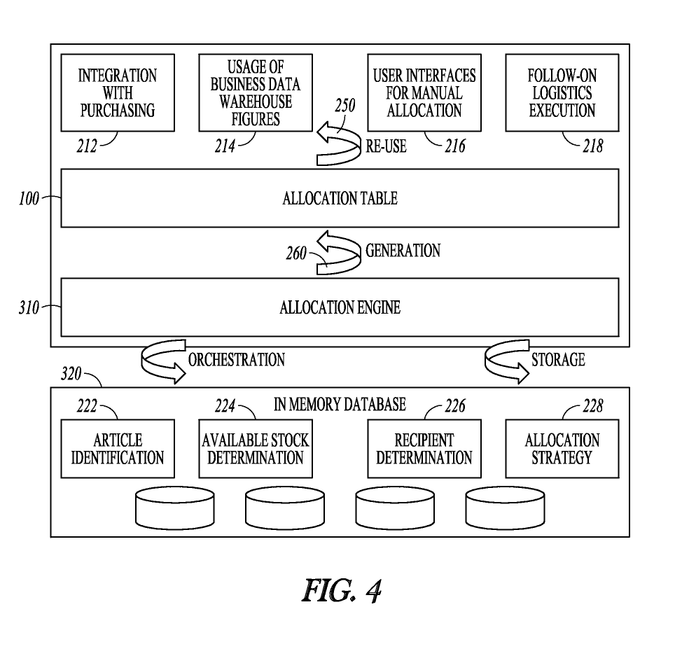

In another embodiment, or sometime after an implementation of the embodiment of FIG. 3, the data required for the allocation process can be stored initially and entirely on the in-memory database. This embodiment is illustrated in FIG. 4. For both the embodiments of FIG. 3 and FIG. 4, the design idea of the allocation engine outlines a high re-use of the ACS automated store allocation in current systems. However, the solution provides a novel product that primarily provides core allocation processing steps as content/procedures on an in-memory database that are orchestrated by the allocation engine on current systems. The relocation of these core allocation processing steps onto an in-memory database offers the chance to dispense with some restrictions of the standard allocation table and offer new flexibility to the retail community. For example, the use of the in-memory database enables cross-item allocation strategies. Cross-item allocation strategies enable the processing of allocation calculation logic for several articles in one joint calculation run. A benefit of cross-item allocation is that the allocation of one article has visibility and access on both the intermediate and final allocation results of another article. The allocation logic can then take into account affinities between different articles. For example, a clothing top and matching bottom should be allocated in the same way since they are usually bought together as a combo by shoppers. In prior standard allocation tables, this is not possible. That is, standard allocation strategies only have access/visibility to one single article. Even various colors and sizes of a style are not forwarded to the allocation strategy together. Instead, each single color/size combination is processed by an execution of the standard single-item allocation strategy.

The advantages of the in-memory systems of FIGS. 3 and 4 over the traditional allocation systems of FIGS. 1 and 2 include and can be summarized as follows. The orchestration of allocation services on an in-memory system and a traditional system can be performed in an integrated/non-disruptive allocation process flow. The generation of allocation tables as standard data objects in a traditional system guarantees a full integration scenario and a standard document flow in the traditional system. Embedding into a standard allocation table framework of a traditional allocation system enables the re-use of already existing standard capabilities like integration with ordering and logistics execution as well as user interfaces for the manual review and interaction on allocation results as calculated on the in-memory system and its new architecture. Allocation services on the in-memory system can use open, flexible, and freely-definable anchor points for custom-specific allocation calculation logic. There is support of on-the-fly calculation, accumulation, and aggregation scenarios for allocation KPIs instead of pre-calculation in a business data warehouse and remote retrieval by allocation processes. The on-the-fly calculation in an in-memory system real-time KPIs further enables real-time allocation processing.

Additionally, a user can receive direct feedback on any changes in the settings (a what-if analysis) and can achieve much better results by focusing on optimizing and not controlling the allocation processes. Also, an allocation engine can immediately be used in a traditional allocation system. Finally, there is not a great deal of implementation work required since major parts of already existing allocation table implementation in a traditional allocation system can be re-used. Consequently, a user can focus on acceleration and elaboration of new use cases as they are outlined by the new in-memory database technology.

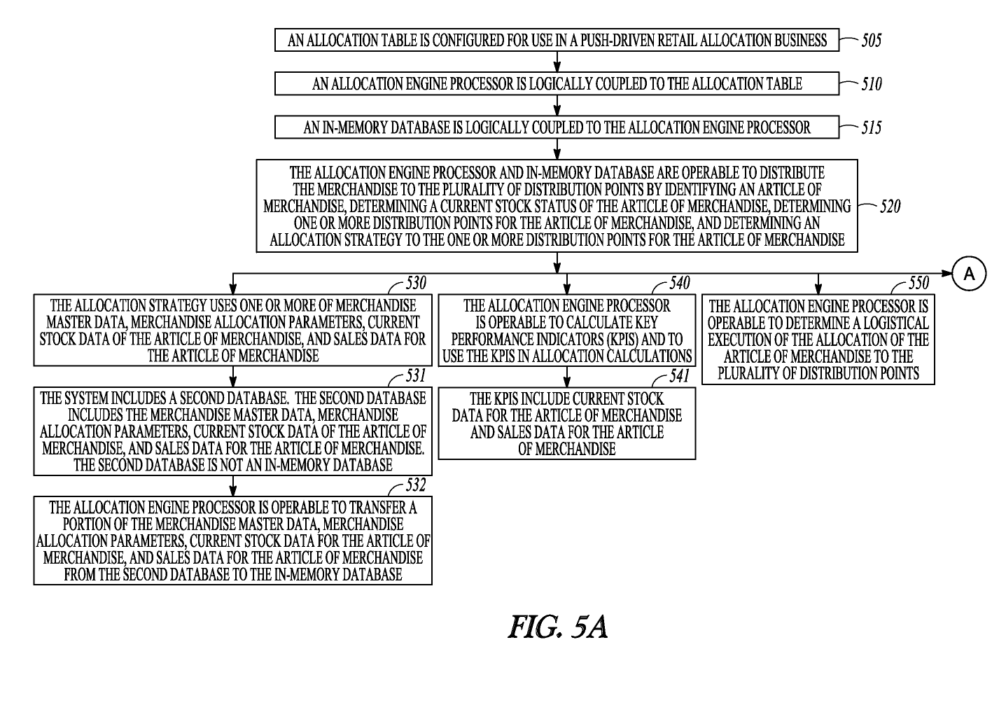

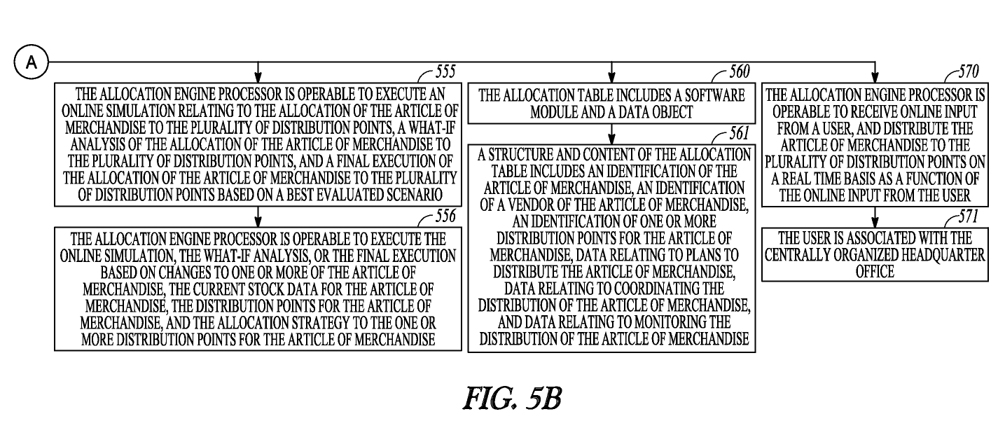

FIGS. 5A and 5B are a block diagram illustrating operations and features of an allocation system embedded in an in-memory database. FIGS. 5A and 5B include a number of operation, process, and feature blocks 505-571. Though arranged serially in the example of FIGS. 5A and 5B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 5A and 5B, at 505, an allocation table is configured for use in a push-driven retail allocation business. The push-driven retail allocation business includes a centrally organized headquarter office and a plurality of distribution points. Merchandise is procured by the centrally organized headquarter office and distributed under the guidance of the centrally organized headquarter office to the plurality of distribution points. At 510, an allocation engine processor is logically coupled to the allocation table, and at 515, an in-memory database is logically coupled to the allocation engine processor. The use of an in-memory database contributes to the real-time capabilities of the system. At 520, the allocation engine processor and in-memory database are operable to distribute the merchandise to the plurality of distribution points by identifying an article of merchandise, determining a current stock status of the article of merchandise, determining one or more distribution points for the article of merchandise, and determining an allocation strategy to the one or more distribution points for the article of merchandise.

At 530, the allocation strategy uses one or more of merchandise master data, merchandise allocation parameters, current stock data of the article of merchandise, and sales data for the article of merchandise. The merchandise master data can include article characteristics such as fashion grade, assortment grade, color, and print; the classification of articles in the article hierarchy; the size scale of an article; the assignment of stores to regions; and the assignment of supplying warehouses to stores and article groups. The merchandise allocation parameters can include such things as minimum/maximum values, a putaway percentage for the warehouse; and minimum picking quantities. At 531, the system includes a second database. The second database includes the merchandise master data, merchandise allocation parameters, current stock data of the article of merchandise, and sales data for the article of merchandise. It is noted that in this embodiment, the second database is not an in-memory database. At 532, the allocation engine processor is operable to transfer a portion of the merchandise master data, merchandise allocation parameters, current stock data for the article of merchandise, and sales data for the article of merchandise from the second database to the in-memory database.

At 540, the allocation engine processor is operable to calculate key performance indicators (KPIs) and to use the KPIs in allocation calculations. At 541, the KPIs include current stock data for the article of merchandise and sales data for the article of merchandise. For example, when the stock of an article of merchandise is low and its sales are high, the allocation engine processor can limit the number of articles distributed to each distribution point so as to deal with the limited stock and high sales of the article.

At 550, the allocation engine processor is operable to determine a logistical execution of the allocation of the article of merchandise to the plurality of distribution points. For example, the allocation engine processor may be configured to distribute a higher number of articles to a more densely populated geographic area than a more sparsely populated geographic area. Alternatively, the allocation engine processor may be configured to distribute more articles to the more sparsely populated area if the past sales in that area are greater than the sales in the more densely populated geographic area. Additionally, a person at the centrally organized headquarter office can manually make such distributions via a user interface. At 555, the allocation engine processor is operable to execute an online simulation relating to the allocation of the article of merchandise to the plurality of distribution points, a what-if analysis of the allocation of the article of merchandise to the plurality of distribution points, and a final execution of the allocation of the article of merchandise to the plurality of distribution points based on a best evaluated scenario. Once again, such analyses can be performed by someone at the centrally organized headquarter office. At 556, the allocation engine processor is operable to execute the online simulation, the what-if analysis, or the final execution based on changes to one or more of the article of merchandise, the current stock data for the article of merchandise, the distribution points for the article of merchandise, and the allocation strategy to the one or more distribution points for the article of merchandise. For example, the allocation processor can be configured to generate a number of shirts that should be stocked at a particular distribution point based on the number of pants that are stocked as the particular distribution point.

At 560, the allocation table includes a software module and a data object. At 561, a structure and content of the allocation table includes an identification of the article of merchandise, an identification of a vendor of the article of merchandise, an identification of one or more distribution points for the article of merchandise, data relating to plans to distribute the article of merchandise, data relating to coordinating the distribution of the article of merchandise, and data relating to monitoring the distribution of the article of merchandise, all of which can be distributed to a greater or lesser extent between the software module and the data object.

At 570, the allocation engine processor is operable to receive online input from a user, and distribute the article of merchandise to the plurality of distribution points on a real time basis as a function of the online input from the user. At 571, the user is associated with the centrally organized headquarter office. Once again, this real time capability permits online and what if analyses.

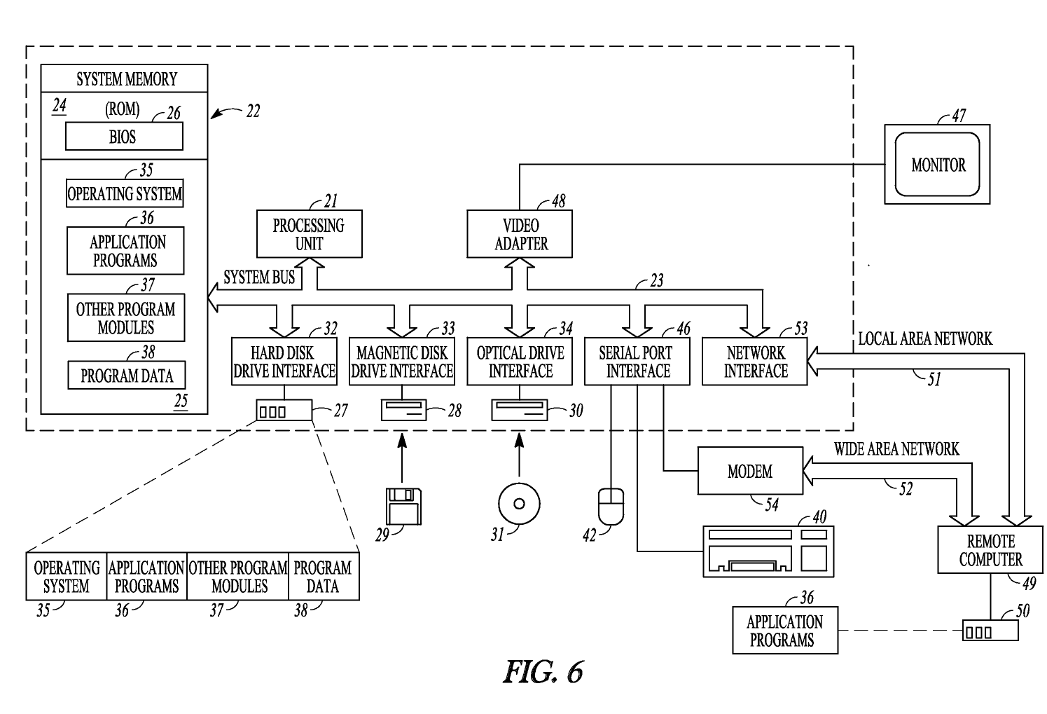

FIG. 6 is an overview diagram of hardware and an operating environment in conjunction with which embodiments of the invention may be practiced. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 6, a hardware and operating environment is provided that is applicable to any of the servers and/or remote clients shown in the other Figures.

As shown in FIG. 6, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 6 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
an allocation table configured for use in a push-driven retail allocation business, the push-driven retail allocation business comprising a centrally organized headquarter office and a plurality of distribution points, wherein merchandise is procured by the centrally organized headquarter office and distributed under guidance of the centrally organized headquarter office to the plurality of distribution points;
an allocation engine processor logically coupled to the allocation table; and
an in-memory database logically coupled to the allocation engine processor;
wherein the allocation engine processor and in-memory database are operable to distribute the merchandise to the plurality of distribution points by identifying an article of merchandise, determining a current stock status of the article of merchandise, determining one or more distribution points for the article of merchandise, and determining an allocation strategy to the one or more distribution points for the article of merchandise.

2. The system of claim 1, wherein the allocation strategy uses one or more of merchandise master data, merchandise allocation parameters, current stock data of the article of merchandise, and sales data for the article of merchandise.

3. The system of claim 2, comprising a second database, the second database comprising the merchandise master data, merchandise allocation parameters, current stock data of the article of merchandise, and sales data for the article of merchandise; wherein the second database is not an in-memory database.

4. The system of claim 3, wherein the allocation engine processor is operable to transfer a portion of the merchandise master data, merchandise allocation parameters, current stock data for the article of merchandise, and sales data for the article of merchandise from the second database to the in-memory database.

5. The system of claim 4, wherein the transfer of the portion of the merchandise master data, merchandise allocation parameters, current stock data for the article of merchandise, and sales data for the article of merchandise from the second database to the in-memory database is based on input from the centrally organized headquarter office.

6. The system of claim 1, wherein the allocation engine processor is operable to calculate key performance indicators (KPIs) and to use the KPIs in allocation calculations.

7. The system of claim 6, wherein the KPIs comprise current stock data for the article of merchandise and sales data for the article of merchandise.

8. The system of claim 1, wherein the allocation engine processor is operable to determine a logistical execution of the allocation of the article of merchandise to the plurality of distribution points.

9. The system of claim 1, wherein the allocation engine processor is operable to execute an online simulation relating to the allocation of the article of merchandise to the plurality of distribution points, a what-if analysis of the allocation of the article of merchandise to the plurality of distribution points, and a final execution of the allocation of the article of merchandise to the plurality of distribution points based on a best evaluated scenario.

10. The system of claim 9, wherein the allocation engine processor is operable to execute the online simulation, the what-if analysis, or the final execution based on changes to one or more of the article of merchandise, the current stock data for the article of merchandise, the distribution points for the article of merchandise, and the allocation strategy to the one or more distribution points for the article of merchandise.

11. The system of claim 1, wherein the allocation table comprises a software module and a data object.

12. The system of claim 11, wherein a structure and content of the allocation table comprises an identification of the article of merchandise, an identification of a vendor of the article of merchandise, an identification of one or more distribution points for the article of merchandise, data relating to plans to distribute the article of merchandise, data relating to coordinating the distribution of the article of merchandise, and data relating to monitoring the distribution of the article of merchandise.

13. The system of claim 1, wherein the allocation engine processor is operable to:
receive online input from a user; and
distribute the article of merchandise to the plurality of distribution points on a real time basis as a function of the online input from the user.

14. The system of claim 13, wherein the user is associated with the centrally organized headquarter office.

15. A computer readable medium comprising:
an allocation table configured for use in a push-driven retail allocation business, the push-driven retail allocation business comprising a centrally organized headquarter office and a plurality of distribution points, wherein merchandise is procured by the centrally organized headquarter office and distributed under guidance of the centrally organized headquarter office to the plurality of distribution points;
wherein the allocation table is logically coupled to an allocation engine processor;
wherein the allocation table is logically coupled to an in-memory database; and
wherein the computer readable medium comprises instructions to:
distribute the merchandise to the plurality of distribution points by identifying an article of merchandise, determining a current stock status of the article of merchandise, determining one or more distribution points for the article of merchandise, and determining an allocation strategy to the one or more distribution points for the article of merchandise.

16. The computer readable medium of claim 15,
wherein the allocation strategy uses one or more of merchandise master data, merchandise allocation parameters, current stock data of the article of merchandise, and sales data for the article of merchandise;
wherein the computer readable medium comprises a second database, the second database comprising the merchandise master data, merchandise allocation parameters, current stock data of the article of merchandise, and sales data for the article of merchandise, and wherein the second database is not an in-memory database;
wherein the computer readable medium comprises instructions to transfer a portion of the merchandise master data, merchandise allocation parameters, current stock data for the article of merchandise, and sales data for the article of merchandise from the second database to the in-memory database; and
wherein the transfer of the portion of the merchandise master data, merchandise allocation parameters, current stock data for the article of merchandise, and sales data for the article of merchandise from the second database to the in-memory database is based on input from the centrally organized headquarter office.

17. The computer readable medium of claim 15, comprising instructions to determine a logistical execution of the allocation of the article of merchandise to the plurality of distribution points.

18. The computer readable medium of claim 15, comprising instructions to execute an online simulation relating to the allocation of the article of merchandise to the plurality of distribution points, a what-if analysis of the allocation of the article of merchandise to the plurality of distribution points, and a final execution of the allocation of the article of merchandise to the plurality of distribution points based on a best evaluated scenario.

19. The computer readable medium of claim 18, comprising instructions to execute the online simulation, the what-if analysis, or the final execution based on changes to one or more of the article of merchandise, the current stock data for the article of merchandise, the distribution points for the article of merchandise, and the allocation strategy to the one or more distribution points for the article of merchandise.

20. The computer readable medium of claim 15, comprising instructions to receive online input from a user; and distribute the article of merchandise to the plurality of distribution points on a real time basis as a function of the online input from the user.
